(19) United States
(12) Patent Application Publication
(10) Pub. No.: US 2014/0210358 A1
(43) Pub. Date: Jul. 31, 2014

(54) LIGHT EMITTING DIODE DRIVING CIRCUIT

(71) Applicant: CHUN LUNG CHIANG, Taipei Hsien (TW)

(72) Inventor: CHUN LUNG CHIANG, Taipei Hsien (TW)

(21) Appl. No.: 13/752,353

(22) Filed: Jan. 28, 2013

(51) Int. Cl. H05B 37/02

(52) U.S. Cl. CPC H05B 37/02
USPC 315/186; 315/201

(57) ABSTRACT

An light emitting diode driving circuit includes an inductor having one end receiving a pulse DC voltage input and another end forwardly-biased and electrically; a power switch connected to another end of the inductor and a first amplifier circuit; the first amplifier circuit serving for converting a first current flowing through the power switch into a first voltage; a second amplifier circuit serving for converting a second current flowing through the LED module into a second voltage; and a comparator circuit comparing the first voltage with a reference voltage; when the first voltage being smaller than the reference voltage, the power switch is conducted; otherwise it is not conducted; the comparator circuit further comparing a second voltage with the reference voltage, when the second voltage is greater than the reference voltage, the power switch is not conducted continuously; otherwise, it is conducted. Thereby, the LED module is driven.

### FIELD OF THE INVENTION

The present invention related to a driving circuit, and in particular to a light emitting diode driving circuit.

### BACKGROUND OF THE INVENTION

LEDs have the advantages of high light emitting efficiency, long lifetime, wide view angle, high contrast, small volume, power saving, difficult to be destroyed, no heat radiation, no pollution of mercury, and easy manufacturing, etc. Therefore, LEDs have become a popular and widely accept new light source.

Since the illumination of the LED is based on the forward biased current flowing therethrough, the larger the forward biased current, the greater the illumination. Likewise, heat generated will increase. Thus, the specification of LEDs will indicate maximum average current (Iavg) and transient peak current (Ipeak) for use for a long period. Generally, the peak current is larger than the average current, i.e., the peak current will induce the maximum illumination of the LEDs, but the LED cannot be used continuously, while although the average current is smaller, it can retain the illumination of the LED in uniform. Therefore, to cause the conversion of AC to DC to be steady for outputting it to the LEDs, in the prior art, pulse width modulation controllers are used, while the DC output is controlled to be stead by installing rectifying diode and filtering capacitor. Therefore, a filtering capacitor with a larger capacitance is necessary. As a result, the volume of the circuit is large and the cost of elements cannot be saved. If it is desired to have lower harmonic waves and high power efficiency, extra power factor corrector is needed. If the AC current is rectified by a bridge rectifier and then resistors are used to limit the amount of current flowing through the light emitting diode, the heat consumption through the resistors are overlarge so that photoelectric conversion efficiency is lower and unnecessary power consumption occurs.

### SUMMARY OF THE INVENTION

Therefore, object of the present invention is to provide a light emitting diode driving circuit without needing power factor corrector and filtering capacitor; AC power is directly as input power, while the present invention achieves the effect of high efficient electric to optic conversion, lower harmonic distortion and high power factor. Furthermore, the volume of the circuit is reduced effectively and the cost is down greatly.

To achieve above mentioned effect, the present invention provides a light emitting diode driving circuit, wherein the light emitting diode driving circuit comprising:

a bridge rectifier receiving an AC power input for rectifying the AC power and outputting pulse DC voltage;

an inductor L1 having one end electrically coupled to the bridge rectifier for receiving the pulse DC voltage and having another end forwardly-biased and electrically coupling to one end of a LED module;

a power switch having a first end, a second end and a controlled end for determining conduction or non-conduction of the first end and the second end; the first end being electrically coupled to the another end of the inductor;

a first amplifier circuit electrically coupled to the second end of the power switch; the first amplifier circuit converting and amplifying a first current flowing through the power switch to a first voltage with a first amplification factor;

a second amplifier circuit forwardly-biased and electrically coupled to another end of the LED module; and the second amplifier circuit converting and amplifying a second circuit flowing through the LED module to a second voltage with a second amplification factor;

a switch driving circuit electrically coupled to the controlled end of the power switch for controlling the conduction and non-conduction of the power switch; when the power switch is conducted, the first current flowing through the inductor and then to the power switch so that the inductor stores energy therein and the first amplifier circuit outputs the first voltage; when the power switch is not conducted, the inductor releases energy to cause the second current flowing through the LED module and the second amplifier circuit outputs the second voltage;

a D type flip-flop which is enabled by a trigger signal to the input end of a clock input end thereof; and a Q end thereof being electrically coupled to the switch driving circuit for controlling the conduction and non-conduction of the power switch through the switch driving circuit; and

a comparator circuit receiving the first voltage and the second voltage; and comparing the first voltage with the reference voltage to determine whether the first voltage is smaller than the reference voltage; if yes, it outputting a logic 1 to the D type flip-flop so as to conduct the power switch through the switch driving circuit; otherwise, the comparator circuit outputting a logic 0 to the D type flip-flop so as not to conduct the power switch through the switch driving circuit; and the comparator circuit comparing the second voltage with the reference voltage; when the comparator circuit determines that the second voltage is greater than the reference voltage, it outputs a logic 0 to the D type flip-flop to cause the power switch not to conduct continuously through the switch driving circuit; otherwise, the comparator circuit outputting a logic 1 to the D type flip-flop so as to control the power switch to conduct through the switch driving circuit; and the comparator circuit comparing the first voltage and the reference voltage again.

Preferably, the comparator circuit includes a 2×1 multiplexer and a comparator; the 2×1 multiplexer receiving the first voltage and the second voltage; when the 2×1 multiplexer selects to output the first voltage to compare with the reference voltage and when the first voltage is smaller than the reference voltage, the comparator outputs a logic 1 until the first voltage is greater than or equal to the reference voltage; and the comparator outputs a logic 0, at the same time, the 2×1 multiplexer being controlled to output the second voltage to compare with the reference voltage; moreover, when the 2×1 multiplexer selects to output the second voltage to compare with the reference voltage and when the second voltage is greater than the reference voltage, the comparator outputs a logic 0 until the first voltage is smaller than or equal to the reference voltage; and the comparator outputs a logic 1, and at the same time, the 2×1 multiplexer being controlled to output the first voltage to compare with the reference voltage.

Preferably, the reference voltage includes an upper limit voltage and a lower limit voltage; and the trigger signal is a first clock; and the comparator circuit comprises:

an upper limit comparator circuit receiving the first voltage and comparing the first voltage with the upper limit voltage; when the first voltage is greater than or equal to the upper limit voltage, the upper limit comparator circuit outputs a logic 0, otherwise, it outputs a logic 1;

a lower limit comparator circuit receiving the second voltage and comparing the second voltage with the lower limit voltage; when the second voltage is smaller than or equal to the lower limit voltage, the lower limit comparator circuit outputs a logic 1, otherwise the logic 0 is outputted;

a first AND gate having an input end connected to the Q end of the D type flip-flop and having another input end connected to an output end of the upper limit comparator circuit;

a second AND gate having an input end connected to the Q̅ end of the D type flip-flop and having another input end connected to an output end of the lower limit comparator circuit; and

a first OR gate having two input ends connected to output ends of the first AND gate and the second AND gate, respectively; and an output end of the first OR gate being connected to a D end of the D type flip-flop.

Preferably, the first amplifier circuit includes a first resistor and a first amplifier; the first resistor is serially connected to the second end of the power switch so that the first current flows through the first resistor to have a first voltage reduction; the first amplifier circuit is electrically coupled to a joint between the first resistor and the power switch for having the first voltage reduction and amplifying the first voltage reduction based on a first amplification factor so as to output the first voltage;

the second amplifier circuit includes a second resistor and a second amplifier; the second resistor is serially connected to another end of the LED module so that the second current flows through the second resistor to have a second voltage reduction; the second amplifier circuit is electrically coupled to a joint between the second resistor and the LED module for having the second voltage reduction and amplifying the second voltage reduction based on a second amplification factor so as to output the second voltage.

the upper limit comparator circuit includes an upper limit voltage generating circuit and a first comparator; the upper limit voltage generating circuit includes a third resistor R3 and a fourth resistor R4; one end of the third resistor R3 is serially connected to one end of the fourth resistor R4; another end of the third resistor R3 is grounded; and another end of the fourth resistor R4 receives a pulse DC voltage for voltage-dividing the pulse DC voltage; a voltage reduction of the third resistor R3 is derived from a joint between the third resistor R3 and the fourth resistor R4 as an upper limit voltage;

the lower limit comparator circuit includes a lower limit voltage generating circuit and a second comparator; the lower limit voltage generating circuit includes a fifth resistor R5 and a sixth resistor R6; one end of the firth resistor R5 is serially connected to one end of the sixth resistor R6; another end of the fifth resistor R5 is grounded; and another end of the sixth resistor R6 receives the pulse DC voltage for voltage-dividing the pulse DC voltage; a voltage reduction of the fifth resistor R5 is derived from a joint between the fifth resistor R5 and the sixth resistor R6 as an lower limit voltage.

Preferably, the first amplification factor of the first amplifier is set based on an upper limit factor F_{RIP,UP} which is larger than 1, an AC voltage V_{AC}, a turns ratio N of a voltage reduction transformer, a continuous current rated value I_{LED,CONT} of the LED module, a total voltage reduction V_{LED} of the LED module, and a specific safety ratio F_{DeRate}.

the first amplification factor

$$A 1 = \frac{1}{R 1} ( \frac{R 3}{R 3 + R 4} \frac{1}{{F}_{RIP , UP} * {F}_{DeRate} * {I}_{LED , CONT}} \frac{{V}_{A C}^{2}}{{N}^{2} * {V}_{LED}} ) ,$$

the second amplification factor A2 of the first amplifier AMP2 is set based on a lower limit coefficient F_{RIP,DN} which is smaller than 1, an AC voltage V_{AC}, the turns ratio N of a voltage reduction transformer, the continuous current rated value I_{LED,CONT}, a total voltage reduction V_{LED} of the LED module and a specific safety ratio F_{DeRate}; and

the second amplification factor

$$A 2 = \frac{1}{R 2} ( \frac{R 5}{R 5 + R 6} \frac{1}{{F}_{RIP , DN} * {F}_{DeRate} * {I}_{LED , CONT}} \frac{{V}_{A C}^{2}}{{N}^{2} * {V}_{LED}} ) ,$$

Preferably, when the resistance of the fifth resistor is identical to that of the third resistor; the resistance of the sixth resistor is identical to that of the fourth resistor; and the resistance of the second resistor is identical to that of the first resistor, than the second amplification factor A2=(F_{RIP,UP}/F_{RIP,DN})*A1

Preferably, the present invention further comprises an exclusive OR gate and a second OR gate; an input end of the exclusive OR gate being connected to the D end of the D type flip-flop, and another end thereof being connected to a Q end of the D type flip-flop; and an output end of the exclusive OR gate being connected to an input end of the second OR gate; the first clock is connected to another end of the second OR gate and an output end of the second OR gate is connected to the clock input end of the D type flip-flop; operations of the D type flip-flop being controlled based on outputs of the exclusive OR gate and a second clock generating from the first clock.

Preferably, the present invention further comprising a voltage reduction transformer with a turns ratio N greater than 1 for voltage reduction of an external DC current so as to generate an AC power voltage which is smaller than the total voltage reduction V_{LED} of the LED module.

Advantages of the present invention are that no power factor calibrator and filtering capacitor are used and AC power source is directly used a power input source, while high power efficient electric-optical conversion is achieved with lower harmonic distortion and high power factors. Furthermore, cost is down and the circuit volume is reduced.

### BRIEF DESCRIPTION OF THE DRAWINGS

FIG. 1 shows the circuit about the light emitting diode driving circuit in the first embodiment of the present invention.

FIG. 2 is a schematic view showing the range of the inductor current i_{L} which is between an upper limit current iUP and a lower limit current iDN according to the first embodiment of the present invention.

FIG. 3 shows the circuit of the light emitting diode driving circuit in the second embodiment of the present invention.

FIG. 4 shows circuit of the present invention, wherein a comparator circuit in a PIC16(L)F1503 microchip is illustrated for realizing the embodiment of the present invention.

FIG. 5 shows a single comparator circuit for replacing the proceeding embodiment which includes two comparator circuits, a first AND gate, a second AND gate and a first OR gate.

FIG. 6 shows the structure of the present invention, wherein a comparator circuit in the PIC 12F615 microchip is illustrated, which is used to realize the comparator circuit in FIG. 5.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

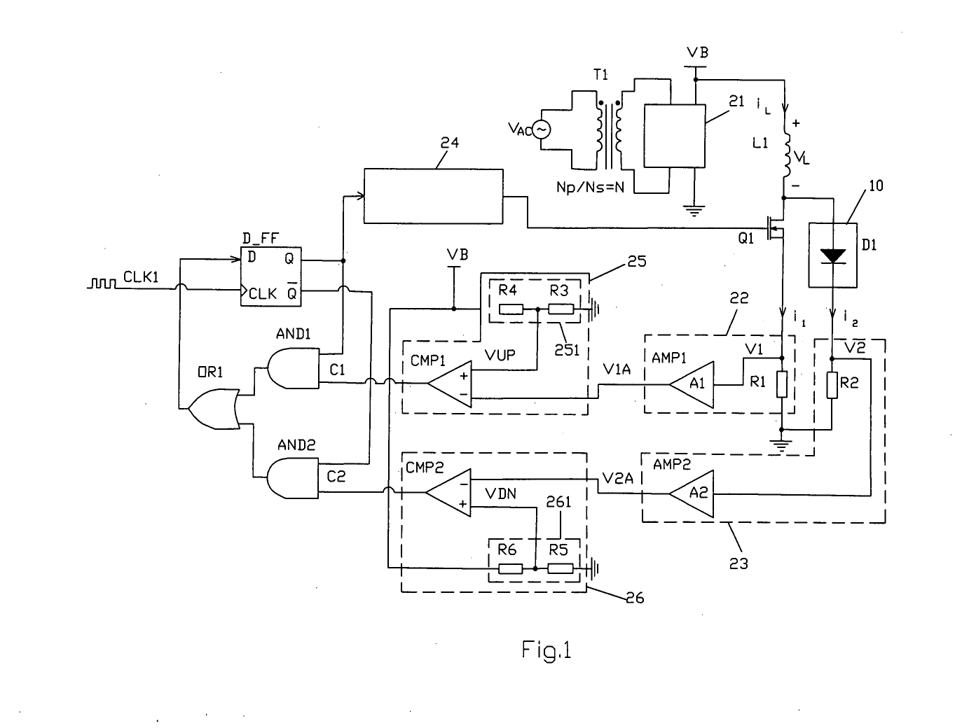

With reference to FIG. 1, the light emitting diode (LED) driving circuit LED in accordance with the present invention serves to drive an LED module 10 which is composed of a plurality of LEDs (connected in parallel or in series) D1 or at least one LED D 1. The first preferred embodiment of the present invention comprises a bridge rectifier 21, an inductor L 1, a power switch Q 1, a first amplifier circuit 22, a second amplifier circuit 23, a switch driving circuit 24, an upper limit comparator circuit 25, a lower limit comparator circuit 26, a D type flip-flop D_FF, a first AND gate AND1, a second AND gate AND2, a first OR gate OR1 and a first clock CLK1. In the following, the logic 1 represents a high level signal and the logic 0 represents a lower level signal.

A bridge rectifier 21 receives an AC power input V_{AC} for full-wave rectifying the AC current to output a pulse DC voltage VB.

An inductor L1 has one end coupling to the bridge rectifier 21 for receiving the pulse DC voltage VB. To cause the inductor L1 to work normally without burning down due to continuously power charge, the total voltage reduction V_{LED} of the LED module 10 must be large than the peak value VP (=\sqrt{2}VB) of the pulse DC voltage VB. For example, if the external AC voltage V_{AC} is 110V from external power source, the total voltage reduction V_{LED} of the LED module 10 must larger than \sqrt{2}×110. If the total voltage reduction V_{LED} of the LED module 10 is smaller than the peak value VP of the pulse DC voltage VB, a voltage reduction transformer T1 with a turns ratio N>1 is coupled to a front end of the bridge rectifier 21 for properly reducing the external system voltage so that the total voltage reduction V_{LED} of the LED module 10 is greater than the peak value VP of the pulse DC voltage VB.

Preferably, a power switch Q1 of this embodiment is a MOSFET (Metal oxide semiconductor field effect transistor) switch. A drain of the MOSFET is forwardly coupled to another end of the inductor L1 and one end of the LED module 10.

A first amplifier circuit 22 is electrically coupled to a second end (source) of the power switch Q 1. A first current i1 flowing through the power switch Q1 is converted and amplified by a first amplification factor A1 to have a first voltage V1A. In this embodiment, the first amplifier circuit 22 includes a first resistor R1 and a first amplifier AMP1. One end of the first resistor R1 is connected to the second end (source) of the power switch Q1. Another end thereof is grounded so that the first current i1 flows through the first resistor R1 to have a first voltage reduction V1 in the first resistor R1. The first amplifier AMP1 is connected to the end of the first resistor R1 connected to the power switch Q1 so as to have the first voltage reduction V1 which is amplified by the first amplification factor A1 to output the first voltage V1A.

A second amplifier circuit 23 is electrically coupled to another end of the LED module 10. By the second amplifier circuit 23, the second current i2 of the LED module 10 is converted and amplified through a second amplification factor A2 to have a second voltage V2A. The second amplifier circuit 23 includes a second resistor R2 and a second amplifier AMP2. One end of the second resistor R2 is connected to another end of the LED module 10 and another end thereof is grounded such that when the second current i2 flows through the second resistor R2 will generate a second voltage reduction V2. The second amplifier AMP2 is connected to the end of the second resistor R2 connected to the LED module 10 so as to have the second voltage reduction V2 and is amplified by a second amplification factor A2 to output a second voltage V2A.

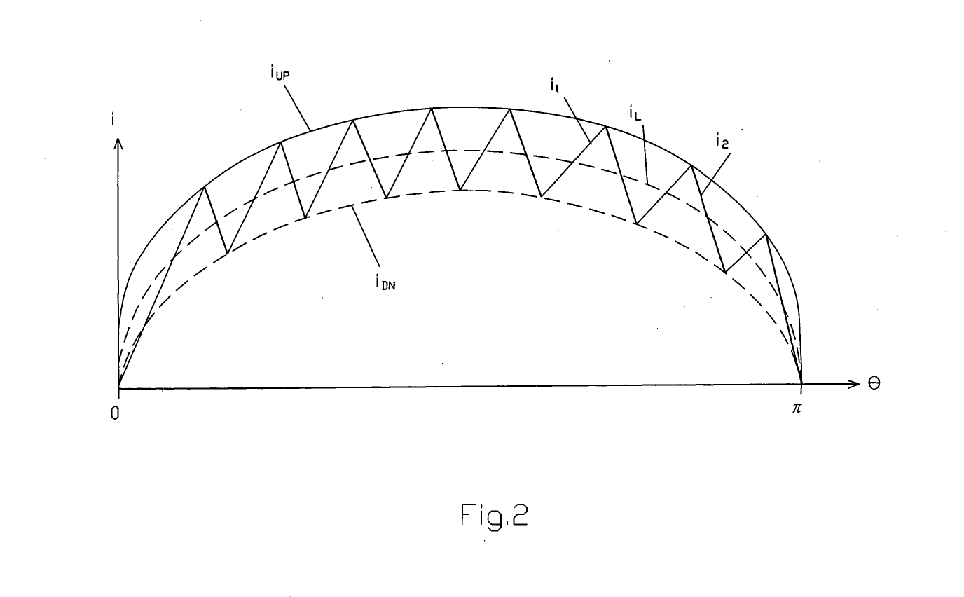

With reference to FIG. 2, to steadily drive the LED module 10, in this embodiment, it is desired to limit the inductor current iL between an upper limit current iUP and a lower limit current iDN that is, the first current i1 is not over the upper limit current iUP, and the second current i2 is not lower than the lower limit current iDN. Therefore, the first amplification factor A1 will cause the first voltage VIA at the output end of the first amplifier AMP1 is larger than or at least equal to the upper limit voltage VUP when the first current i1 approaches to the upper limit current iUP. Similarly, the second amplification factor A2 will cause the second voltage V2A at the output end of the second amplifier AMP2 is smaller than or at least equal to the lower limit voltage VDN when the second current i2 approaches to the lower limit current iDN.

Besides, since it is known that a continuous rated current of the LED module 10 is I_{LED,CONT}, to cause the root mean square value of the second current i2 flowing through the LED module 10 is not over the continuous rated current I_{LED,CONT} of the LED module 10, in this embodiment, it is set that that the root mean square value of the second current i2 is equal to the continuous rated current I_{LED,CONT} multiple with a specific safety ratio F_{DeRate} which is smaller than 1. Furthermore, the first amplification factor A1 of the first amplifier AMP1 is set based on an upper limit factor F_{RIP,UP} which is larger than 1, an AC voltage V_{AC}, a turns ratio N of the voltage reduction transformer, the continuous current rated value I_{LED,CONT} of the LED module 10, the total voltage reduction V_{LED} of the LED module 10, and the specific safety ratio F_{DeRate}.

Then the first amplification factor

$$A 1 = \frac{1}{R 1} ( \frac{R 3}{R 3 + R 4} \frac{1}{{F}_{RIP , UP} * {F}_{DeRate} * {I}_{LED , CONT}} \frac{{V}_{A C}^{2}}{{N}^{2} * {V}_{LED}} ) ,$$

Moreover, the second amplification factor A2 of the first amplifier AMP2 is set based on a lower limit coefficient F_{RIP,DN} which is smaller than 1, the AC voltage V_{AC}, the turns ratio N of the voltage reduction transformer, the continuous current rated value I_{LED,CONT}, the total voltage reduction V_{LED} of the LED module 10, and the specific safety ratio.

Therefore, the amplification factor:

$$A 2 = \frac{1}{R 2} ( \frac{R 5}{R 5 + R 6} \frac{1}{{F}_{RIP , DN} * {F}_{DeRate} * {I}_{LED , CONT}} \frac{{V}_{A C}^{2}}{{N}^{2} * {V}_{LED}} )$$

If the resistance of the fifth resistor R5 is equal to that of the third resistor R3, the resistance of the sixth resistor R6 is equal to that of the fourth resistor R4, and the resistance of the second resistor R2 is equal to that of the first resistor R1. Then the second amplification factor A2=(F_{RIP,UP}/F_{RIP,DN})*A1

The switch driving circuit 24 is electrically coupled to the gate (controlled end) of the power switch Q1 for controlling conduction or non-conduction between the drain and source of the power switch Q 1. When the power switch Q1 is conducted, the first current i1 flows through the inductor L1 and then through the power switch Q1 so that the inductor L 1 will store energy (be charged), and meanwhile the first amplifier circuit 22 outputs the first voltage V1A. When the power switch Q1 is not conducted, the inductor L 1 will release energy (discharge) and the second current i2 flows through the LED module 10 so that the LED module 10 emits light. At the same time, the second amplifier circuit 23 outputs the second voltage V2A.

The upper limit circuit 25 receives the first voltage VIA and compares the first voltage VIA with the upper limit voltage VUP. When the first voltage VIA is larger than or equal to the upper limit voltage VUP, the upper limit comparator circuit 25 outputs a logic 0, otherwise, a logic 1 is outputted. In detail, the upper limit comparator circuit 25 includes an upper limit voltage generating circuit 251 and a first comparator CMP1. The upper limit voltage generating circuit 251 includes a third resistor R3 and a fourth resistor R4 which are serially connected. Another end of the third resistor R3 is grounded and another end of the fourth resistor R4 receives a pulse DC voltage VB for voltage-dividing the pulse DC voltage VB. The upper limit voltage VUP is the voltage reduction of the third resistor R3 and is derived from the joint between the third resistor R3 and the fourth resistor R4. The positive input end of the first comparator CMP1 receives the upper limit voltage VUP and a negative end thereof receives the first voltage VIA. Furthermore, the first comparator CMP1 compares the upper limit voltage VUP and the first voltage V1A. The output end C 1 of the first comparator CMP1 outputs a logic 0 or a logic 1 based on the result of the comparison.

The lower limit comparator circuit 26 receives the second voltage

V2A and compares the second voltage V2A with a lower limit voltage VDN. When the second voltage V2A is smaller than or equal to the lower limit voltage VDN. The lower limit comparator circuit 26 outputs a logic 1. Otherwise it outputs a logic 0. In detail, the lower limit comparator circuit 26 includes a lower limit voltage generating circuit 261 and a second comparator CMP2. The lower limit voltage generating circuit 261 includes a fifth resistor R5 and a sixth resistor R6 which are serially connected. Another end of the fifth resistor R5 is grounded. Another end of the sixth resistor R6 receives the pulse DC voltage VB for voltage-dividing the pulse DC voltage VB. The lower limit voltage VDN is the voltage reduction of the fifth resistor R5 and is derived from a joint between the fifth resistor R5 and the sixth resistor R6. A positive input end of the second comparator CMP2 receives the lower limit voltage VDN and a negative input end thereof receives the second voltage V2A and compares the lower limit voltage VDN with the first voltage V1A. Then an output end C2 of the second comparator CMP2 output a logic 0 or a logic 1 based on the comparison results.

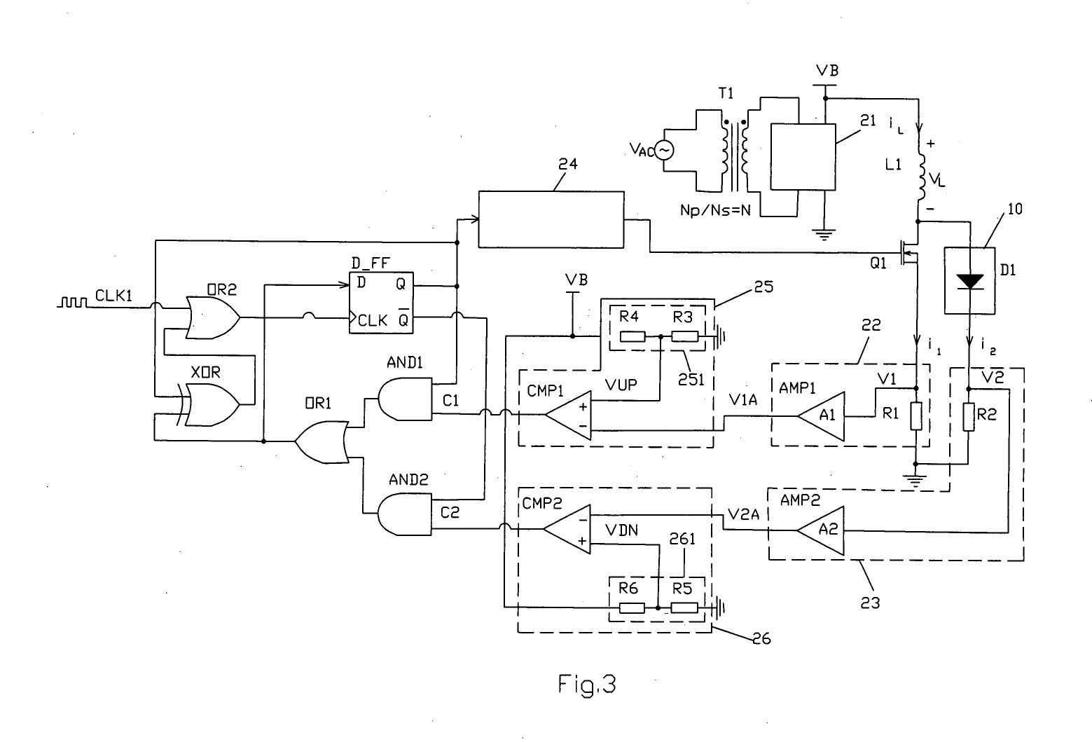

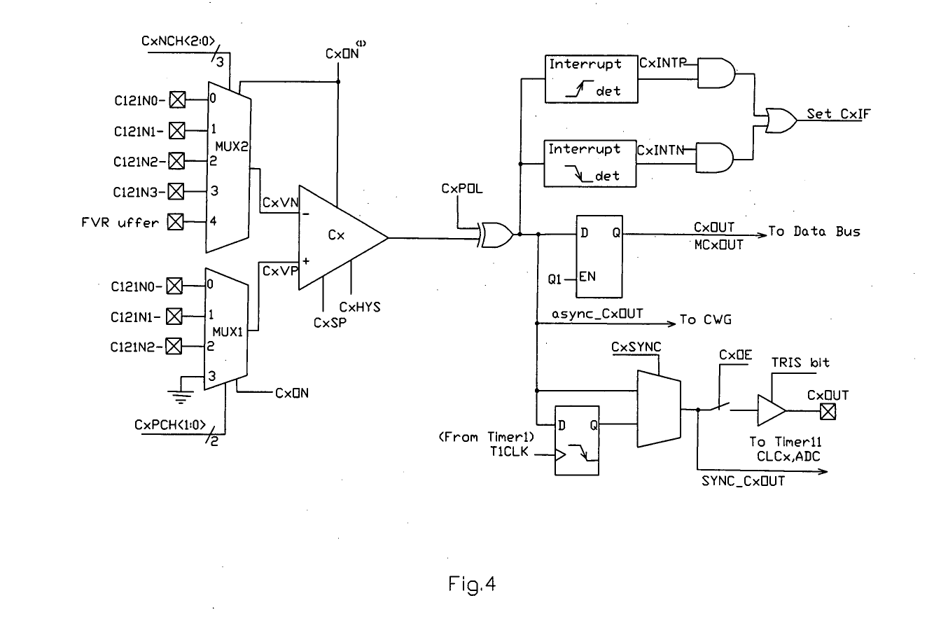

Referring to FIGS. 3 and 4, the D type flip-flop D_FF acts based on a trigger signal to the clock input end CLK. In this embodiment, the trigger signal is a first clock CLK1. A Q end thereof is connected to the switch driving circuit 24 for controlling the conduction of Q1 through the switch driving circuit 24. An input end of a first AND gate AND1 is connected to the Q end of the D type flip-flop D_FF. Another end thereof is connected to an output end (i.e., an output end C1 of the first comparator CMP1) of the upper limit comparator circuit 25. An input end of a second AND gate AND2 is connected to the Q̅ end of the D type flip-flop D_FF and another end thereof is connected to the output end (i.e., the output end C2 of the second comparator CMP2) of the lower limit comparator circuit 26. An input end of the first OR gate OR1 is connected to an output end of the first AND gate AND1 and another end of the first OR gate OR1 is connected to an output end of the second AND gate AND2. An output end of the first OR gate OR1 is connected to a D end of the D type flip-flop D_FF. Therefore, the input of the D end is related to the output end C1 of the first comparator CMP1, the output end C2 of the second comparator CMP2, an output of the Q end and an output of the Q̅ end. It can be represented by a logic operation, which is D=Q·C1+ Q̅·C2. Furthermore, the output end of Q end of the D type flip-flop D_FF is determined by the input of the D end.

Thus, when the Q end of the D type flip-flop D_FF outputs a logic 1. The switch driving circuit 24 will conduct the power switch Q1. The first current i1 flows through the inductor L1 and then through the power switch Q1 so that the inductor L 1 is charged and thus stores energy. Meanwhile, the first voltage VIA increases gradually. When the first voltage V1A is still smaller than the upper limit voltage VUP to cause the output end C1 of the first comparator CMP1 output a logic 1, the Q end of the D type flip-flop D_FF outputs a logic 1 continuously. As a result, the switch driving circuit 24 conducts the power switch Q1 continuously. At this moment, since the Q end of the D type flip-flop D_FF outputs logic 0, the second AND gate AND2 still outputs a logic 0.

When the first voltage V1A increases to be greater than or equal to the upper limit voltage VUP, so that the output end C1 of the first comparator CMP1 output a logic 0, the first AND gate AND1 output a logic 0, and meanwhile, the second AND gate AND2 output a logic 0 continuously so that the first OR gate OR1 outputs a logic 0 to the D end of the D type flip-flop D_FF to cause the Q end thereof outputs a logic 0 to control the switch driving circuit 24 not to conduct the power switch Q1. As a result, the inductor L1 will release energy and generates a second current i2 which flows through the LED module 10 to drive the LED module 10 to light up. Simultaneously, the Q end of the D type flip-flop D_FF outputs a logic 1 to the second AND gate AND2 and the Q end of the D type flip-flop D_FF outputs a logic 0 to the first AND gate AND1 to cause the first AND gate AND1 to output logic 0 continuously. Meanwhile, the second amplifier circuit 23 outputs the second voltage V2A to the second comparator CMP2. At this time, since the second voltage V2A is greater than the lower limit voltage VDN, the second comparator CMP2 outputs a logic 0 to the second AND gate AND2 to cause the second AND gate AND2 to output logic 0 continuously to the first OR gate OR1. As a result, the Q end of the D type flip-flop D_FF to output logic 0 continuously to cause the switch driving circuit 24 still not to conduct the power switch Q1, but the second current i2 will decrease due to the discharge of the inductor L1 to drive the second voltage V2A to descend gradually. When the second voltage V2A descends to be smaller or equal to the lower limit voltage VDN, the second comparator CMP2 outputs a logic 1 to the second AND gate AND2 to cause that the first AND gate AND1 to output a logic 1 to the D end of the D type flip-flop D_FF. As a result, the Q end of thereof will output a logic 1 to control the switch driving circuit 24 to conduct the power switch Q1 again. Then, the inductor L 1 will be charged again to store energy until the first voltage VIA to increase again to be greater than or equal to the upper limit voltage VUP of the first comparator CMP1. Then, the inductor L 1 discharges to the LED module 10. Thereby, the circuit operates continuously to achieve the effect of drive the LED module 10 to light.

With reference to FIG. 3, the second preferred embodiment of the LED driving circuit of the present invention is illustrated. Other than those elements illustrated in above first embodiment, this embodiment further includes an exclusive OR gate XOR and a second OR gate OR2. The exclusive OR gate XOR has an input end connected to the D end of the D type flip-flop D_FF and another end thereof is connected to the Q end of the D type flip-flop D_FF. An output end of the exclusive OR gate XOR is connected to an input end of the second OR gate OR2. A first clock CLK1 is connected to another input end of the second OR gate OR2 and an output end of the second OR gate OR2 is connected to the clock input end CLK (generally, it is a positive trigger edge) of the D type flip-flop D_FF. A second clock CLK2 is generated to control the operation of the D type flip-flop D_FF based on the output of the exclusive OR gate XOR and the first clock CLK1 (the clock pulse is better to has a narrower pulse). Thereby, when in a transient period that states of the D end and Q end of the D type flip-flop D_FF are contrary to one another, an extra trigger signal is generated to input to the clock input end of the D type flip-flop D_FF to cause the Q end of the D type flip-flop D_FF to be synchronous to the D end of the D type flip-flop D_FF thereof. No next pulse of the first clock CLK1 is needed to be triggered. Therefore, the switch driving circuit 24 can conduct or non-conduct the power switch Q1 real time. Thus, the variation of the second current i2 flowing through the LED module 10 is not over a control range. Thus the LED module 10 is controlled steadily.

Above mentioned first comparator CMP1 and the second comparator CMP2 can be realized by the comparator module Cx of a PIC16(L)F1503 microchip. As illustrated in FIG. 4, the comparator module Cx includes two comparators, a first comparator C1 (x=1) and a second comparator C2(x=2). A receiving end of a first multiplexer MUX1 receives an upper limit voltage VUP (or a lower limit voltage VDN) and an output end thereof is connected to a positive input end CxVP of the comparator module Cx. An input end of the second multiplexer MUX2 receives a first voltage VIA (or a second voltage V2A) and an output end thereof is connected to a negative input end CxVN of the comparator module Cx. Thereby, when the first comparator C 1 is driven, the first multiplexer MUX1 outputs the upper limit voltage VUP to the first comparator C 1 and the second multiplexer MUX2 outputs the first voltage V1A to the first comparator C1 to compare with the upper limit voltage VUP. When the second comparator C2 is driven, the first multiplexer MUX1 outputs the lower limit voltage VDN to the second comparator C2, and the second multiplexer MUX2 outputs the second voltage V2A to the second comparator C2 to be compared with the lower limit voltage VDN. Then the comparing results of the first comparator C 1 and the second comparator C2 are read by next elements or software.

Besides, it should be noted that in above embodiment, AC power source is used as the driving power of the LED module 10, but DC power source is still acceptable. That is, it is only to cancel the transformer T1 and the bridge current rectifier 21 in above embodiment so that DC voltage directly applies to the inductor L1 and the voltage of the DC voltage must be smaller than the total voltage reduction of the LED module 10, and then the operations of the whole circuits are identical to the above mentioned embodiments. The differences between the DC and AC are that in DC source, the upper limit voltage VUP and lower limit voltage VDA are fixed; and the first voltage V1A and the second voltage V2A are DC voltages varied between the upper limit voltage VUP and the lower limit voltage VDN.

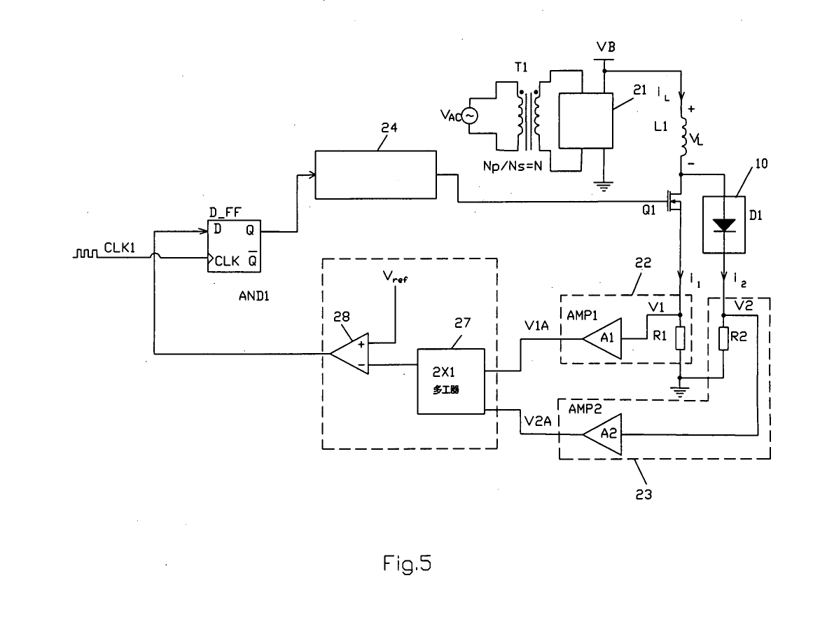

Moreover, as shown in FIG. 5, when it is set that the upper limit voltage VUP and the lower limit voltage VDN are identical (in the following, it is called as a reference voltage Vref), it is only needed to use a 2×1 multiplexer 27 and a comparator 28 (for example, an upper comparator circuit 25) to replace the above mentioned first comparator 25, the second comparator 26, the first AND gate AND 1, the second AND gate AND2 and the first OR gate OR1. Two inputs end of the multiplexer 27 are connected to the output ends of the first amplifier AMP1 and the first amplifier AMP2. The output end of the multiplexer 27 is connected to the negative input end of the comparator 28. The positive input end of the comparator 28 receives the reference voltage Vref and the output end of the comparator 28 is directly connected to the D end of the D type flip-flop D_FF.

Therefore, initially, the multiplexer 27 selects to output the first voltage VIA to be compared with the reference voltage Vref. When the first voltage VIA is smaller than the reference voltage Vref, the comparator 28 will output a logic 1 to the D type flip-flop D_FF so that the D type flip-flop outputs a logic 1 to control the switch driving circuit 24 to drive the power switch Q1 to conduct, until the first voltage V1A is greater than or equal to the reference voltage Vref; or the comparator 28 output a logic 0 to the D type flip-flop D_FF so as to output a logic 0 to control the switch driving circuit 24 not to conduct the power switch Q1. Meanwhile, the multiplexer 27 is controlled to output the second voltage V2A to be compared with the reference voltage Vref. When the second voltage V2A is greater than the reference voltage Vref, the comparator 28 will output a logic 0 to the D type flip-flop D_FF so as to continuously output the logic 0 to control the switch driving circuit 24 not to conduct, until the second voltage V2A is reduced to be smaller than or equal to the reference voltage Vref; or the comparator 28 outputs a logic 1 to the D type flip-flop D_FF to output logic 1 to control the switch driving circuit 24 to conduct the power switch Q1 again and at the same time, it control the multiplexer 27 to output the first voltage V1A. Thereby, the object of driving the LED module 10 to emit light is achieved.

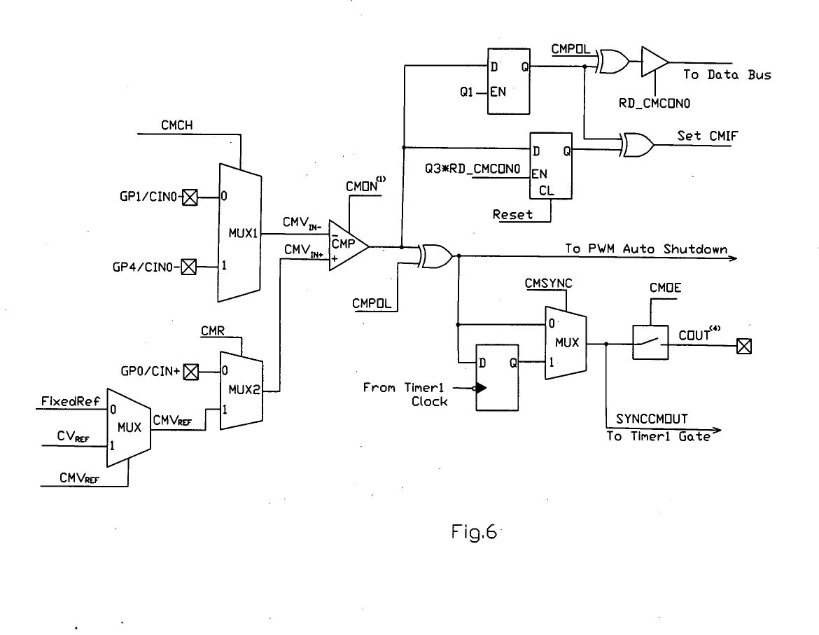

The 2×1 multiplexer 27 and the comparator 28 can be realized by the comparator CMP, multiplexers MUX1 and MUX2 in the PIC12F615 microchip. As illustrated in FIG. 6, the first voltage V1A and second voltage V2A are input to the pins GP1/CIN0 and GP4/CIN1 of the multiplexer MUX1. The reference voltage is input to the pin GPO/CIN+ of the multiplexer MUX2. The output end of the multiplexer MUX1 is connected to the negative end CMV_{IN-} of the comparator CMP and the output end of the multiplexer MUX2 is connected to the positive input end CMV_{IN+} of the comparator CMP.

In summary, in above embodiments, no power factor corrector and filtering capacitor are used and AC power source is directly used as power input source, while high power efficient electric-optical conversion is achieved with lower harmonic distortion and high power factor. Furthermore, cost is down and the circuit volume is reduced.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A light emitting diode driving circuit for driving an LED module formed by a plurality of light emitting diodes connected in parallel or in series, the light emitting diode driving circuit comprising:
a bridge rectifier receiving an AC power input for rectifying the AC power and outputting pulse DC voltage;
an inductor L1 having one end electrically coupled to the bridge rectifier for receiving the pulse DC voltage and having another end forwardly-biased and electrically coupling to one end of a LED module;
a power switch having a first end, a second end and a controlled end for determining conduction or non-conduction of the first end and the second end; the first end being electrically coupled to the another end of the inductor;
a first amplifier circuit electrically coupled to the second end of the power switch; the first amplifier circuit converting and amplifying a first current flowing through the power switch to a first voltage with a first amplification factor;
a second amplifier circuit forwardly-biased and electrically coupled to another end of the LED module; and the second amplifier circuit converting and amplifying a second circuit flowing through the LED module to a second voltage with a second amplification factor;
a switch driving circuit electrically coupled to the controlled end of the power switch for controlling the conduction and non-conduction of the power switch; when the power switch is conducted, the first current flowing through the inductor and then to the power switch so that the inductor stores energy therein and the first amplifier circuit outputs the first voltage; when the power switch is not conducted, the inductor releases energy to cause the second current flowing through the LED module and the second amplifier circuit outputs the second voltage;
a D type flip-flop which is enabled by a trigger signal to the input end of a clock input end thereof; and a Q end thereof being electrically coupled to the switch driving circuit for controlling the conduction and non-conduction of the power switch through the switch driving circuit; and
a comparator circuit receiving the first voltage and the second voltage; and comparing the first voltage with the reference voltage to determine whether the first voltage is smaller than the reference voltage; if yes, it outputting a logic 1 to the D type flip-flop so as to conduct the power switch through the switch driving circuit; otherwise, the comparator circuit outputting a logic 0 to the D type flip-flop so as not to conduct the power switch through the switch driving circuit; and the comparator circuit comparing the second voltage with the reference voltage; when the comparator circuit determines that the second voltage is greater than the reference voltage, it outputs a logic 0 to the D type flip-flop to cause the power switch not to conduct continuously through the switch driving circuit; otherwise, the comparator circuit outputting a logic 1 to the D type flip-flop so as to control the power switch to conduct through the switch driving circuit; and the comparator circuit comparing the first voltage and the reference voltage again.

2. The light emitting diode driving circuit as claimed in claim 1, wherein the comparator circuit includes a 2×1 multiplexer and a comparator; the 2×1 multiplexer receiving the first voltage and the second voltage; when the 2×1 multiplexer selects to output the first voltage to compare with the reference voltage and when the first voltage is smaller than the reference voltage, the comparator outputs a logic 1 until the first voltage is greater than or equal to the reference voltage; and the comparator outputs a logic 0; moreover, when the 2×1 multiplexer selects to output the second voltage to compare with the reference voltage and when the second voltage is greater than the reference voltage, the comparator outputs a logic 0 until the first voltage is smaller than or equal to the reference voltage; and the comparator outputs a logic 1 and at the same time, the 2×1 multiplexer outputs the first voltage to compare with the reference voltage.

3. The light emitting diode driving circuit as claimed in claim 1, wherein the reference voltage includes an upper limit voltage and a lower limit voltage; and the trigger signal is a first clock; and the comparator circuit comprises:
an upper limit comparator circuit receiving the first voltage and comparing the first voltage with the upper limit voltage; when the first voltage is greater than or equal to the upper limit voltage, the upper limit comparator circuit outputs a logic 0, otherwise, it outputs a logic 1;
a lower limit comparator circuit receiving the second voltage and comparing the second voltage with the lower limit voltage; when the second voltage is smaller than or equal to the lower limit voltage, the lower limit comparator circuit outputs a logic 1, otherwise the logic 0 is outputted;
a first AND gate having an input end connected to the Q end of the D type flip-flop and having another input end connected to an output end of the upper limit comparator circuit;
a second AND gate having an input end connected to the Q end of the D type flip-flop and having another input end connected to an output end of the lower limit comparator circuit; and
a first OR gate having two input ends connected to output ends of the first AND gate and the second AND gate, respectively; and an output end of the first OR gate being connected to a D end of the D type flip-flop.

4. The light emitting diode driving circuit as claimed in claim 1, wherein
the first amplifier circuit includes a first resistor and a first amplifier; the first resistor is serially connected to another end of the power switch so that the first current flows through the first resistor to have a first voltage reduction; the first amplifier circuit is electrically coupled to a joint between the first resistor and the power switch for having the first voltage reduction and amplifying the first voltage reduction based on a first amplification factor so as to output the first voltage; and
the second amplifier circuit includes a second resistor and a second amplifier; the second resistor is serially connected to another end of the LED module so that the second current flows through the second resistor to have a second voltage reduction; the second amplifier circuit is electrically coupled to a joint between the second resistor and the LED module for having the second voltage reduction and amplifying the second voltage reduction based on a second amplification factor so as to output the second voltage.

5. The light emitting diode driving circuit as claimed in claim 4, wherein
the upper limit comparator circuit includes an upper limit voltage generating circuit and a first comparator; the upper limit voltage generating circuit includes a third resistor R3 and a fourth resistor R4; one end of the third resistor R3 is serially connected to one end of the fourth resistor R4; another end of the third resistor R3 is grounded; and another end of the fourth resistor R4 receives a pulse DC voltage for voltage-dividing the pulse DC voltage; a voltage reduction of the third resistor R3 is derived from a joint between the third resistor R3 and the fourth resistor R4 as an upper limit voltage;
the lower limit comparator circuit includes a lower limit voltage generating circuit and a second comparator; the lower limit voltage generating circuit includes a fifth resistor R5 and a sixth resistor R6; one end of the firth resistor R5 is serially connected to one end of the sixth resistor R6; another end of the fifth resistor R5 is grounded; and another end of the sixth resistor R6 receives the pulse DC voltage for voltage-dividing the pulse DC voltage; a voltage reduction of the fifth resistor R5 is derived from a joint between the fifth resistor R5 and the sixth resistor R6 as an lower limit voltage;

6. The light emitting diode driving circuit as claimed in claim 5, wherein
the first amplification factor of the first amplifier is set based on an upper limit factor FRIP,UP which is larger than 1, an AC voltage VAC, a turns ratio N of a voltage reduction transformer, a continuous current rated value ILED,CONT of the LED module, a total voltage reduction VLED of the LED module, and a specific safety ratio FDeRate.
the first amplification factor
$$A 1 = \frac{1}{R 1} ( \frac{R 3}{R 3 + R 4} \frac{1}{{F}_{RIP , UP} * {F}_{DeRate} * {I}_{LED , CONT}} \frac{{V}_{A C}^{2}}{{N}^{2} * {V}_{LED}} ) ,$$
the second amplification factor A2 of the first amplifier AMP2 is set based on a lower limit coefficient FRIP,DN which is smaller than 1, an AC voltage VAC, the turns ratio N of a voltage reduction transformer, the continuous current rated value ILED,CONT, a total voltage reduction VLED of the LED module and a specific safety ratio FDeRate; and the second amplification factor
$$A 2 = \frac{1}{R 2} ( \frac{R 5}{R 5 + R 6} \frac{1}{{F}_{RIP , DN} * {F}_{DeRate} * {I}_{LED , CONT}} \frac{{V}_{A C}^{2}}{{N}^{2} * {V}_{LED}} )$$

7. The light emitting diode driving circuit as claimed in claim 6, wherein when the resistance of the fifth resistor is identical to that of the third resistor; the resistance of the sixth resistor is identical to that of the fourth resistor; and the resistance of the second resistor is identical to that of the first resistor, than the second amplification factor A2=(FRIP,UP/FRIP,DN)*A1

8. The light emitting diode driving circuit as claimed in claim 7, further comprising an exclusive OR gate and a second OR gate; an input end of the exclusive OR gate being connected to the D end of the D type flip-flop, and another end thereof being connected to a Q end of the D type flip-flop; and an output end of the exclusive OR gate being connected to an input end of the second OR gate; the first clock is connected to another end of the second OR gate and an output end of the second OR gate is connected to the pulse input end of the D type flip-flop; operations of the D type flip-flop being controlled based on outputs of the exclusive OR gate and a second clock generating from the first clock.

9. The light emitting diode driving circuit as claimed in claim 1, further comprising a voltage reduction transformer with a turns ratio N greater than 1 for voltage reduction of an extra DC current so as to generate an AC power which is smaller than the total voltage reduction VLED of the LED module.
